(19) United States
(12) Patent Application Publication
(10) Pub. No.: US 2006/0154020 A1
(43) Pub. Date: Jul. 13, 2006

(54) Nonwoven base fabric for reinforcing

(76) Inventors: Akira Kasuya, Neyagawa-shi, Osaka (JP); Wataru Horimoto, Neyagawa-shi, Osaka (JP); Kazuya Kusu, Osaka-shi, Osaka (JP); Yoshikazu Maegawa, Osaka-shi, Osaka (JP)

Correspondence Address: BIRCH STEWART KOLASCH & BIRCH, PO BOX 747, FALLS CHURCH, VA, 22040-0747, US

(21) Appl. No.: 10/541,532

(22) PCT Filed: Mar. 25, 2004
(86) PCT No.: PCT/JP04/04165

§ 371 Date: Jul. 8, 2005

(30) Foreign Application Priority Data
Oct. 1, 2003 (JP) 2003-343255

(51) Int. Cl. B32B 5/16; B32B 5/12; B32B 5/26

(52) U.S. Cl. 428/105; 428/107; 428/109; 428/113; 442/361; 442/365; 442/366; 442/381; 442/409

(57) ABSTRACT

A reinforcing non-woven base fabric that is formed through processes in which a group of warp yarns, composed of a plurality of reinforcing fiber yarns that are aligned in a fixed direction with fixed intervals or closely, is superposed on a group of fusion-bonding multifilament yarns made of composite fibers that are aligned in a direction perpendicular to the fixed direction so that the two groups are bonded to each other through fusion-bonding, and a manufacturing method and a manufacturing machine for such a reinforcing non-woven base fabric.

### TECHNICAL FIELD

The present invention relates to a reinforcing non-woven base fabric that is used for externally reinforcing and repairing a concrete structure, and also concerns a reinforcing non-woven base fabric used for FRP.

### BACKGROUND ART

In order to reinforce and repair FRP or a concrete structure, a so-called high-strength fiber sheet having a specific gravity smaller than metal and strength higher than metal is inserted or bonded thereto.

The high-strength fibers are allowed to further increase the strength thereof when a number of fibers are arranged in a direction in which greater strength is required. However, the high-strength fibers in a yarn state cause difficulty in handling and time-consuming tasks in aligning yarns one by one; therefore, the high-strength fibers in a sheet state are used in most cases.

With respect to the high-strength fiber sheet, a sheet made by forming glass fibers into a sheet shape has been known (for example, see Japanese Patent Application Laid-Open No. 8-142238, FIG. 2, and Japanese Patent Application Laid-Open No. 2001-159047).

In the case when glass fibers are formed into a sheet shape, a material prepared by impregnating glass fibers with a bonding-agent solution is generally used, and high-strength fibers, for example, carbon fiber yarns, are bonded to the material to maintain the sheet shape. The glass fiber yarn is composed of not a single fiber, but a bunch of glass fibers, with the result that voids tend to exist between fibers. Even when the bunch of glass fibers is impregnated with the bonding-agent solution, these voids are not filled with the solution. Depending on the bonding agents, during drying and bonding processes after the impregnation, voids tend to generate inside the fiber yarns. Consequently, a reinforcing non-woven base fabric including a number of voids therein is used for reinforcing FRP or a concrete structure, with the result that the strength of the reinforced FRP or the reinforced concrete is lowered. A bonding agent, such as an acrylic resin, a nylon resin and polyester, to be normally used for bonding the high-strength fibers and the shape-retaining fibers to each other tends to absorb moisture during production and storage, with the result that the adhesive property to the matrix of the FRP or the concrete is lowered to cause a reduction in the reinforcing performance. The moisture is evaporated to expand to sometimes cause a deformation in the matrix resin and damages thereto. The glass fibers that have been often used conventionally has a high specific gravity, that is, in a level of 2.5, to cause an increase in the weight per unit area as a whole and insufficient flexibility; consequently, the conventional glass fibers cause a difficulty in handling due to an insufficient following property to curved faces and the like.

### DISCLOSURE OF INVENTION

(Technical Subjects to be Solved by the Present Invention)

The present invention has been made to solve the above-mentioned problems, and its objective is to provide a reinforcing non-woven base fabric that is free from adverse effects such as moisture-absorbing property and voids, and capable of exerting superior properties such as flexibility and light weight.

(Means to Solve Problems)

The present invention relates to a reinforcing non-woven base fabric that is made by forming reinforcing fiber yarns into a sheet shape using a support fibrous member, and in the reinforcing non-woven base fabric, the support fibrous member is made of multifilament yarns using composite fibers constituted by at least two or more polymers having a difference in melting points.

### BRIEF DESCRIPTION OF DRAWINGS

FIG. 1 is a schematic structural drawing that shows a fusion-bonding mesh manufacturing machine;

FIG. 2 is a schematic structural drawing that shows a reinforcing non-woven base fabric manufacturing machine of the present invention;

FIG. 3 is a schematic structural drawing that shows a glass mesh manufacturing machine;

FIG. 4 is an electron microscopic photograph that shows a fiber form in a cross-section of a reinforcing non-woven base fabric obtained in example 1;

FIG. 5 is a schematic structural drawing that shows a reinforcing non-woven base fabric manufacturing machine;

FIG. 6 is an electron microscopic photograph that shows a fiber form in a cross-section of a reinforcing non-woven base fabric obtained in comparative example 1;

FIG. 7 is a schematic cross-sectional view of a monofilament used for a support fibrous member;

FIG. 8 is a schematic cross-sectional view of a reinforcing non-woven base fabric in accordance with the present invention.

### BEST MODE FOR CARRYING OUT THE INVENTION

Reinforcing fiber yarns forming a sheet-shaped member of the present invention include carbon fibers, glass fibers, boron fibers, steel fibers, aramid fibers, vinylon fibers and the like, and are made of multifilaments that form a flat shape without twists. The multifilaments are preferably designed to have a degree of flatness of not less than 2, more preferably not less than 10; here, the degree of flatness is defined as a ratio of the width to the thickness. Particularly preferable degree of flatness is in a range from 20 to 700. Here, the multifilaments having a degree of flatness in a range from 20 to 700 are obtained by further subjecting multifilaments that have a flat shape without twists to a fiber-opening process.

The fiber-opening process refers to a process in which a bunch of fibers, which is an aggregate of a plurality of filaments, are separated in the fiber width direction, and the fiber-opening process is applied to the bunch of fibers so that the width of the bunch of fibers is further widened. Those yarns obtained through the fiber-opening process are referred to as fiber extended yarns. In the present invention, with respect to the multifilaments or laminated multifilaments, those having a width that is widened 2 to 5 times, preferably 2 to 4 times, the width of the original multifilaments through the fiber-opening process may be used. For example, a carbon-fiber multifilament having a width of about 6 mm, formed by combining 12,000 carbon fibers having a diameter of 7 μm with one another, is subjected to a fiber-opening process to form a flat multifilament (fiber extended yarn) having a width of 20 mm.

With respect to the support fibrous member to be used in the present invention, composite fibers, constituted by at least two or more polymers having a difference in melting points, are used. The composite fiber means the one in which an arrangement of respective components in a cross section is shown in various morphology, such as parallel, core-sheath, grains, radiation, mosaic, sea islands and nebula. From the viewpoint of productivity, shape-retaining property and fusion-bonding property, a two-layered product with two components having a core-sheath structure is preferably used. Preferably, composite fibers having a core-sheath structure in which the sheath portion is formed by a polymer having a lower melting point than that of the core portion are used. From the viewpoint of productivity, the difference in melting points is preferably not less than 20° C., more preferably not less than 30° C. In the case of the application of fibers made of a single component, the fibers might be cut in a fusion-bonding process; however, the application of fibers using polymers having a difference in melting points makes it possible to prevent the support fibrous member from being cut or deformed when the reinforcing fiber yarns and the support fibrous member are thermally fusion-bonded at a melting temperature on the low melting point side. The support fiber member is flattened by thermo-compression processes, and the degree of irregularities in the thickness direction is consequently lowered, resulting in excellence in flatness.

The support fibrous member to be used in the present invention is constituted by multifilament yarns using composite fibers. The application of monofilament is not desirable because the monofilament lacks in flexibility. In the case when multifilaments consisting of a single fiber are used, it becomes very difficult to remove voids derived from gaps between the single fibers as described earlier; consequently, the application of the multifilaments of this type is not desirable due to a reduction in strength due to voids. In the present invention, multifilaments, having 30 or more filaments, are preferably used. The thickness of filaments is preferably in a range from 100 d to 1000 d.

With respect to the material for the multifilament yarns, both of a low melting point polymer and a high melting point polymer are preferably olefin-based to form multifilaments. The olefin has a very low specific gravity in comparison with other thermoplastic resins and inorganic fibers. The olefin has a specific gravity of 0.90 to 0.98; in contrast, generally-used polymer materials have a specific gravity of about 1.5 and inorganic fibers have a specific gravity of about 1.8 to 2.7, which is comparatively heavy. The olefin has a hydrophobic property, and has no moisture-absorbing property. Even if any absorbed moisture is present between filaments, the amount thereof is very small, and the moisture evaporates during a fusion-bonding process. More preferably, a combination of a polypropylene polymer serving as the high melting point polymer and polyethylene or low melting point polypropylene serving as a low melting point polymer, that is, a combination of polyolefin polymers in a narrow sense, may be used. More specifically, preferable examples of the structure and material include: a core-sheath structure having a polypropylene (core portion)/polyethylene (sheath portion) combination, or a polypropylene (core portion)/low melting point polypropylene (sheath portion) combination.

Polyolefin-based multifilaments to be used for the support fibrous member of the present invention have no bonding property to high-strength fibers, such as carbon fibers, glass fibers, boron fibers, steel fibers, aramid fibers and vinylon fibers. In the case of conventional support materials for glass fibers, any low melting point binder, such as nylon and polyester, is adhered thereto so that the high-strength fibers and the support fibrous member are bonded to each other; however, in the present invention, no additional binder is required. In other words, the olefin-based polymer of a low-melting portion in composite fibers is anchored onto the high-strength fibers through the fusion-bonding; thus, a sheet shape is retained through a so-called anchor effect. One of the features of the present invention lies in the finding that a sheet-retaining is possible through the anchoring effect, even when low melting point olefin-based multifilaments, which inherently have no adhesive property, are used.

The support fiber material to be used in the present invention allows reinforced fiber yarns to be formed into a sheet shape by using a structure that is different from a fabric, that is, a non-woven fabric structure, and, for example, a method using the support fiber material as wefts and the like and a method using the support fiber material as a mesh structure are proposed.

The mesh structure can be manufactured through the following processes: multifilament yarns made of composite fibers, aligned in a length direction, and multifilament yarns made of composite fibers, aligned in a width direction, are alternately laminated to form two layers and more so as to form an integral sheet shape, and the laminated body is thermo-compressed by applying a temperature lower than the melting temperature of the high melting point polymer thereto. These thermo-compression processes allow the heat bonding resin in low melting point portions in the composite fibers to fuse, making it possible to provide a mesh structure having a stable shape that is free from voids. The mesh structure is formed by alternately laminating two or more layers; therefore, different from a textile or knit structure, the warp is less susceptible to bending, that is, no stress concentration is imposed on the warp. In the present invention, it is not necessarily required for multifilament yarns of composite fibers to be used in both of the length direction and width direction; however, from the viewpoints of a reduced thickness and a stable mesh structure, multifilament yarns of composite fibers are preferably used in both of the two directions.

In the present invention, the reinforcing fiber yarns are retained into a sheet shape by the support fibrous member so that a reinforcing non-woven base fabric is formed.

The shape-retained sheet may be a uniaxial reinforcing fiber sheet in which a plurality of reinforcing fiber yarns are aligned in one direction. Alternatively, the shape-retained sheet may be a biaxial reinforcing fiber sheet in which a warp sheet composed of reinforcing fiber yarns that are aligned in a length direction and a weft sheet composed of reinforcing fiber yarns that are aligned in a width direction are laminated. The shape-retained sheet may be a multi-axial reinforcing fiber yarn sheet that is formed by laminating a yarn sheet made of reinforcing fiber yarns which, supposing that the length direction of the sheet is 0°, are aligned in 0°-direction, a yarn sheet made of reinforcing fiber yarns which are aligned in a +α°-direction as well as in a −α°-direction (0<α<90) and a yarn sheet made of reinforcing fiber yarns which are aligned in a 0°-direction and/or in a 90°-direction. With respect to the mode in which the reinforcing fiber yarns are aligned, they may be aligned with fixed intervals or may be aligned closely.

In the case when the retained shape forms the uniaxial reinforcing fiber sheet, a so-called shape-retaining method only by the weft, which places a plurality of support fibrous members side by side in a direction virtually perpendicular to the direction (hereinafter, referred to as “reinforcing fiber yarn direction”) in which the fiber yarns are aligned so that the support fibrous members and the sheet-shaped member are shape-retained through a fusion-bonding process, may be used. In addition to the support fibrous members aligned in the virtually perpendicular direction, a plurality of support fibrous members may be placed side by side virtually in parallel with the reinforcing fiber yarn direction so that the support fibrous members in a mesh state may be fusion-bonded with the sheet-shaped member and shape-retained. In the case when the shape-retaining process is carried out with the support fibrous members being maintained in the mesh state, after the support fibrous members have been preliminarily formed into a desired mesh state through a fusion-bonding process or the like, the resulting mesh-state member may be superposed on the sheet-shaped member and thermally bonded with each other.

When the reinforcing fiber yarns are shape-retained into a uniaxial reinforcing fiber yarn sheet, a structure in which at least two or more layers of reinforcing fiber yarns (for example, the group of warp yarns) and support fibrous members (for example, the group of weft yarns) are laminated with each other is preferably used so that contact points (lines) between the group of warp yarns and the group of weft yarns are fusion-bonded so as to carry out a shape-retaining process. More preferably, as shown in FIG. 8, two upper and lower layers 82 and 83 constituted by groups of warp yarns with a fixed interval are prepared, with an intermediate layer 81 constituted by a group of weft yarns made of support fibrous members being interpolated therebetween to prepare a three-layered structure; thus, a laminated structure in which the lower layer is placed with a ½-pitch offset so that each yarn of the lower-layer yarn group is positioned between the yarns of the upper-layer yarn group is preferably used.

In the case when the retained shape forms the biaxial reinforcing fiber sheet, a sheet in which reinforcing fiber yarns are preliminarily formed in a biaxial format is used and groups of support fibrous member yarns (a plurality of yarns aligned in parallel with one another or in a mesh pattern) may be fusion-bonded and shape-retained on the upper face, intermediate face and/or lower face of the sheet. Simultaneously as the biaxial reinforcing fiber yarns are formed, the support fibrous members may be inserted and fusion-bonded and shape-retained. In this case, the shaping process is preferably carried out so that at least the direction of the support fibrous members and the direction of the reinforcing fiber yarns are allowed to make virtually 90 degrees. Moreover, the uniaxial reinforcing fiber sheet reinforcing non-woven base fabrics, obtained as described above, may be laminated with one another, with the direction of the reinforcing fiber yarns being offset by about 90 degrees, so that these may be again fusion-bonded to obtain a reinforcing non-woven base fabric. Moreover, the uniaxial reinforcing fiber sheet reinforcing non-woven base fabrics prior to the fusion-bonding process may be laminated with one another, with the direction of the reinforcing fiber yarns being offset by about 90 degrees, and fusion-bonded.

In the case when the retained shape forms the multi-axial reinforcing fiber sheet, instead of the structure of the biaxial reinforce fiber sheet in which uniaxial reinforcing fiber sheet reinforcing non-woven base fabrics are laminated with a 90-degree offset, a plurality of the base fabrics may be laminated with an offset of α°-degrees (0<α<90) so that a multi-axial reinforcing fiber sheet reinforcing non-woven base fabric is obtained in the same manner as the biaxial reinforcing fiber sheet reinforcing non-woven base fabric. The size of α may be appropriately selected depending on the number of desired laminated layers.

The fusion-bonding process is carried out while the laminated body of the reinforcing fiber yarns and the support fibrous members is heated and pressurized.

The number of the support fibrous members to be used and the gap between the parallel alignments are not particularly limited as far as the sheet-shaped member is shape-retained, and may be appropriately selected depending on the purpose for the reinforcing non-woven base fabric, the size and the method thereof, as well as on the kind, the width and the manufacturing method of the fiber extended yarns.

The following description will discuss a method for continuously manufacturing a reinforcing non-woven fabric of the present invention, and a machine used for manufacturing such a fabric.

(1) A manufacturing method and a manufacturing machine for a reinforcing non-woven base fabric formed of uniaxial reinforcing fibers.

(i) A reinforcing non-woven base fabric manufacturing machine, which is constituted by at least: a device that continuously supplies a pair of selvage yarns on both of the right and left sides; a device that continuously supplies a weft of multifilament heat-bonding yarn made of composite fibers so that the weft is passed over the paired selvage yarns in a winding manner so as to proceed; a device that continuously supplies a number of warps of reinforcing fiber yarns onto the upper face and lower face of the winding weft to carry out warping and matching processes; and a device which, after the warp and the wefts have been laminated, carries out heating and pressurizing processes to fuse the low-melting portions of the weft so that the warp and the wefts are bonded to each other through the fusion-bonding process, and takes up the joined non-woven base fabric; and a manufacturing method by which the manufacturing machine is operated.

(ii) A reinforcing non-woven base fabric manufacturing machine, which is constituted by at least: a device that continuously supplies a number of warps so as to carry out warping and matching processes; a device that feeds a mesh-shaped sheet formed by multifilament heat bonding yarns made of composite fibers; and a device which, immediately after the warps have been subjected to the warping process and supplied, inserts the mesh-shaped sheet formed by multifilament heat bonding yarns made of composite fibers from the upper portion or the lower portion, or from both of the upper and lower portions, so as to fuse the mesh-shaped sheet by heating and pressurizing so that the mesh-shaped sheet formed by multifilament fusion-bonding yarns made of composite fibers is bonded to a non-woven base fabric through the heat bonding with the warps, and takes up the resulting joined non-woven base fabric; and a manufacturing method by which the manufacturing machine is operated.

(iii) A reinforcing non-woven base fabric manufacturing machine, which is constituted by at least: a device that continuously supplies a pair of selvage yarns on both of the right and left sides; a device that continuously supplies a weft of multifilament fusion-bonding yarn made of composite fibers so that the weft is passed over the paired selvage yarns in a winding manner so as to proceed; a device that continuously supplies a number of warps of reinforcing fiber yarns onto the upper face and lower face of the winding weft; a device that continuously supplies warps of multifilament fusion-bonding yarns made of composite fibers as second warps; a device which places the warps in a manner so as to cover either the upper portion or the lower portion of the warps of reinforcing fiber yarns, and immediately after the resulting warps have been subjected to a warping process, and supplied so that the warps and the weft have been laminated, carries out heating and pressurizing processes to fusion-bond the fusion-bonding yarns used for the warps and weft, while the multifilament fusion-bonding yarns made of composite fibers of the warps and weft and the reinforcing fiber yarns of the warps are fusion-bonded, and takes up the resulting joined non-woven base fabric; and a manufacturing method by which the manufacturing machine is operated.

(2) A reinforcing non-woven base fabric made from biaxial reinforcing fibers.

(i) A reinforcing non-woven base fabric manufacturing machine, which is constituted by at least: a device that continuously supplies a pair of selvage yarns on both of the right and left sides; a device that continuously supplies a multifilament fusion-bonding yarn made from composite fibers and a reinforcing fiber yarn alternately as wefts so that the wefts are passed over the paired selvage yarns in a winding manner so as to proceed; a device that continuously supplies a number of warps of reinforcing fiber yarns onto the upper face and lower face of the winding wefts; a device that continuously supplies warps of multifilament fusion-bonding yarns made of composite fibers as second warps; a device which places the warps in a manner so as to cover either the upper portion or the lower portion of the warps of reinforcing fiber yarns, and immediately after the resulting warps have been subjected to a warping process, and supplied so that the warps and the weft have been laminated, carries out heating and pressurizing processes to heat-bond the multifilament fusion-bonding yarns of composite fibers used for the warps and weft with each other, while the multifilament fusion-bonding yarns made of composite fibers of the warps and weft and the reinforcing fiber yarns of the warps and weft are also fusion-bonded, and takes up the resulting joined non-woven base fabric; and a manufacturing method by which the manufacturing machine is operated.

(ii) A reinforcing non-woven base fabric manufacturing machine, which is constituted by at least: a device that continuously supplies a pair of selvage yarns on both of the right and left sides; a device that continuously supplies a reinforcing fiber yarn as a weft so that the weft is passed over the paired selvage yarns in a winding manner so as to proceed; a device that continuously supplies a number of warps of reinforcing fiber yarns onto the upper face and lower face of the winding weft to carry out warping and matching processes; a device that feeds a mesh-shaped sheet formed by laminating a group of warp yarns and a group of weft yarns that are arranged with fixed intervals through multifilament fusion-bonding yarns made of composite fibers; and a device which, immediately after the warps and wefts have been laminated, inserts a mesh-shaped sheet formed by multifilament fusion-bonding yarns made of composite fibers from the upper portion or the lower portion, or from both of the upper and lower portions, to fuse the mesh-shaped sheet formed by multifilament fusion-bonding yarns made of composite fibers, by heating and pressurizing so that the wefts are bonded to a non-woven base fabric through the heat bonding with the warps, and takes up the resulting joined non-woven base fabric; and a manufacturing method by which the manufacturing machine is operated.

### EXAMPLE 1

An olefin-based heat bonding multifilament (heat bonding PYLEN (registered trademark) 680d; made by Mitsubishi Rayon Co., Ltd.) was used as a support fibrous member. This support fibrous member, which is a multifilament having a core-sheath structure, has a core portion composed of polypropylene having a melting point of 165° C. and a sheath portion composed of polyethylene having a melting point of 98° C., with 60 filaments having a thickness of 680 deniers, and the specific gravity thereof is 0.93.

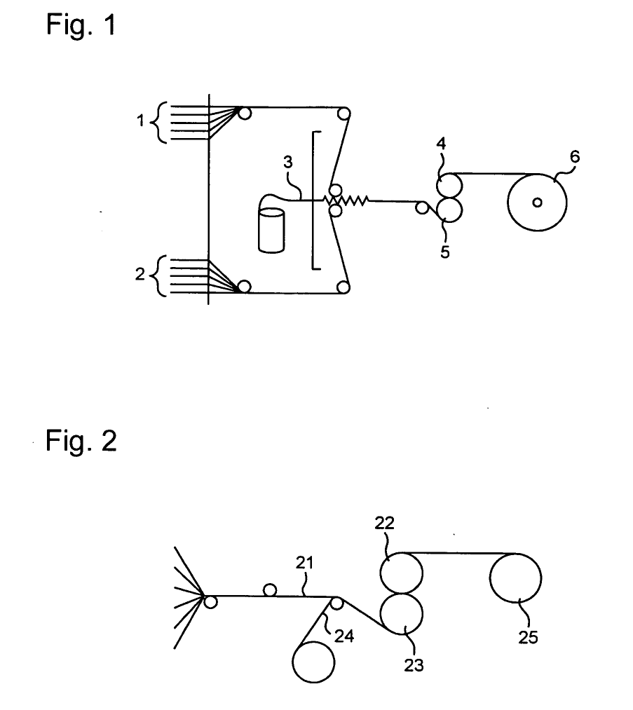

A fusion-bonding mesh was manufactured by using a heat-bonding mesh manufacturing machine as shown in FIG. 1 through the following processes.

The above-mentioned support fibrous member was used to form a mesh pattern in which a group of yarns 1 formed by arranging upper threads in the length direction with 2-cm pitches and a group of yarns 2 formed by arranging lower threads with 2-cm pitches so that each thread is positioned between the upper threads 1 are placed, with a group of yarns 3 formed by arranging the same threads with 1-cm pitches in the width direction being sandwiched therebetween.

This mesh material was fusion-bonded by using upper and lower electric heater rolls with the upper roll being set at 100° C. and the lower roll being set at 80° C., under a nip pressure of 1.0 kg/cm at a line speed of 1 m/min, and wound around a take-up roll 6; thus, a mesh was obtained.

The thickness of the resulting mesh was 0.1 mm at the thinnest portion and 0.12 mm at the thickest portion on each intersection, with a width of the thread being set to 1.2 mm.

Next, a reinforcing non-woven base fabric was manufactured by using a reinforcing non-woven base-fabric manufacturing machine shown in FIG. 2.

A carbon fiber yarn (“PYROFIL (registered trademark)” made by Mitsubishi Rayon Co., Ltd.) was used as a reinforcing fiber in the length direction. The carbon fiber yarns of 12K, each having a yarn width of about 6 mm, were arranged in the length direction with 5-mm pitches to form a sheet without gaps; thus, a carbon-fiber yarn sheet 21 was prepared. The above-mentioned fusion-bonded mesh 24 was inserted from under this carbon fiber yarn sheet along the sheet face, and passed between electric heater rolls 22 and 23 placed in upper and lower positions in an S-letter shape, and then fusion-bonded under a nip pressure of 1.0 kg/cm at a roll temperature of 100° C. at a line speed of 1 m/min; thus, a reinforcing non-woven base fabric of the present invention was obtained.

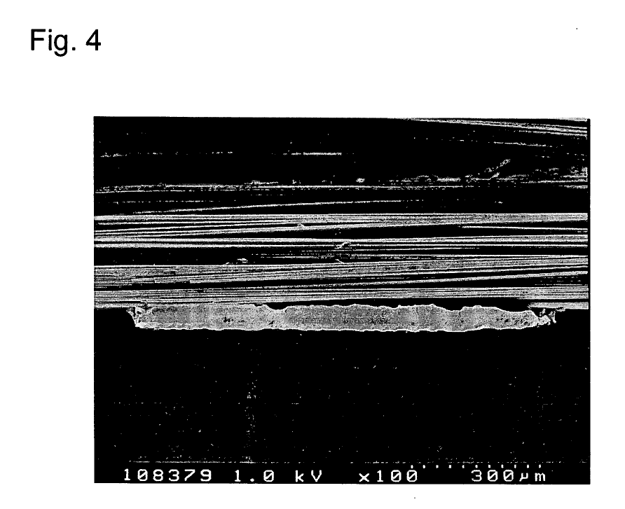

The cross section of the yarn in the width direction of the resulting reinforcing non-woven base fabric was observed under an electron microscope. FIG. 4 shows the photographs. The sheath portions were fused into an integral part, while each of the core portions was maintained in its original shape. No voids such as bubbles were observed between the support fibrous members. The reinforcing non-woven base fabric was bonded to the carbon fiber yarn sheet through an anchor effect by polyethylene that forms the sheath portions having a low melting point.

The one-direction reinforced carbon fiber yarn sheet was bound through the anchor effect by an olefin mesh that had no water-absorbing property, and since the olefin mesh was inherently thin and flexible, the resulting reinforcing non-woven base fabric was flexible, and also allowed to maintain its sheet shape. Moreover, since the olefin mesh, used for the binding material, contained no bubbles, the reinforcing non-woven base fabric was less susceptible to a reduction in its strength, even when used for FRP or the like.

Even when the thickness of the fibers (filaments) to be used for the fusion-bonded mesh was made thinner to 340 d or 170 d, there was no change in the binding effect; thus, it is found that these fibers can be used for forming a reinforcing non-woven base fabric.

Since olefin-based heat-bonding multifilament fibers are used, the specific gravity thereof is smaller than glass fibers. Therefore, even in the case of the same fineness, the actual cross-sectional area of the yarn is greater than that of the glass fibers.

The thickness of each of yarns formed into a net is shown below for comparison.

| | |
|---|---|
| Glass mesh | 0.6 mm |
| Fusion-bonded mesh (680d) | 1.2 mm |
| Fusion-bonded mesh (340d) | 1.0 mm |
| Fusion-bonded mesh (170d) | 0.8 mm |

Since the face made in contact with the reinforcing fiber yarns is allowed to exert the binding effect, the fusion-bonded mesh of 170 d is sufficiently to be used so as to obtain the binding effect in the same level as the glass mesh.

The weight of each of meshes per 1 m² is shown below for comparison.

| | | |
|---|---|---|
| Glass mesh | 16 | g/m² |
| Fusion-bonded mesh (680d) | 15 | g/m² |
| Fusion-bonded mesh (340d) | 7.5 | g/m² |
| Fusion-bonded mesh (170d) | 3.8 | g/m² |

### COMPARATIVE EXAMPLE 1

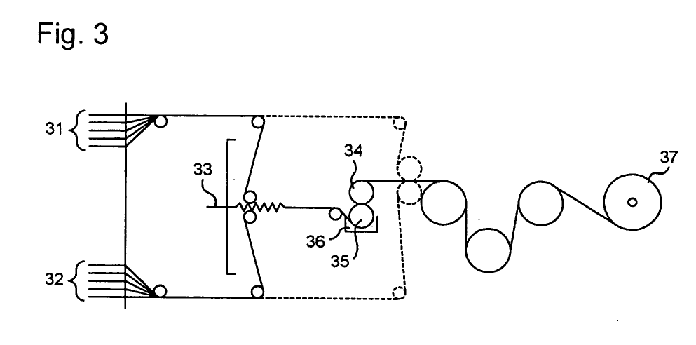

A glass mesh was manufactured by using a glass mesh manufacturing machine shown in FIG. 3 through the following processes.

Glass fiber yarns (thickness: 300 deniers, specific gravity: 2.54) were used as warps to form a mesh pattern in which a group of yarns 31 formed by arranging upper threads in the length direction with 1-cm pitches and a group of yarns 32 formed by arranging lower threads with 1-cm pitches are placed so that each lower thread is superposed on each upper thread, with a group of yarns 33 formed by arranging glass fiber yarns (thickness: 600 deniers, specific gravity 2.54) with 1-cm pitches in the width direction being sandwiched therebetween.

The resulting mesh material was impregnated with a thermoplastic emulsion resin (ethylene-vinyl acetate copolymer resin: solid component 30%) put in a resin vessel 36. Successively, the mesh material was passed through rubber rolls 34 and 35 (diameter: 100 mm, width: 40 cm) placed in upper and lower positions so that the excessive resin was squeezed, and dried by a drying roll at 130° C.; thus, a mash formed of glass fiber yarns was obtained.

The thickness of the resulting mesh was 0.12 mm at the thinnest portion and 0.19 mm at the thickest portion on each intersection, with a width of the thread being 0.6 mm.

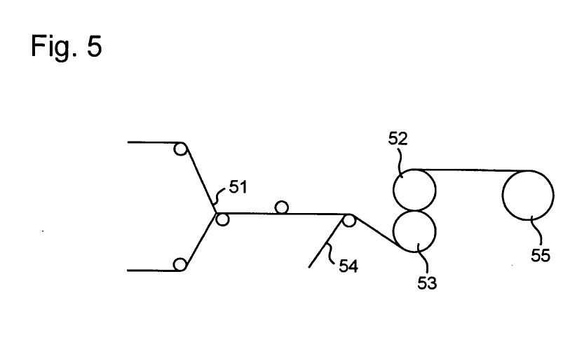

Next, a reinforcing non-woven base fabric was manufactured by using a reinforcing non-woven base-fabric manufacturing machine shown in FIG. 5.

A carbon fiber yarn (“PYROFIL (registered trademark)” made by Mitsubishi Rayon Co., Ltd.) was used as a reinforcing fiber in the length direction. The carbon fiber yarns of 12K, each having a yarn width of about 6 mm, were arranged in the length direction with 5-mm pitches to form a sheet without gaps; thus, a carbon-fiber yarn sheet 51 was prepared. The above-mentioned mesh 54 made of glass fiber yarns was inserted from under this carbon fiber yarn sheet along the sheet face, and passed between electric heater rolls 52 and 53 placed in upper and lower positions in an S-letter shape, and then fusion-bonded under a nip pressure of 30 kg/40 cm at temperatures of upper and lower rolls of 150° C. at a line speed of 1 m/min; thus, a reinforcing non-woven base fabric of the present invention was obtained.

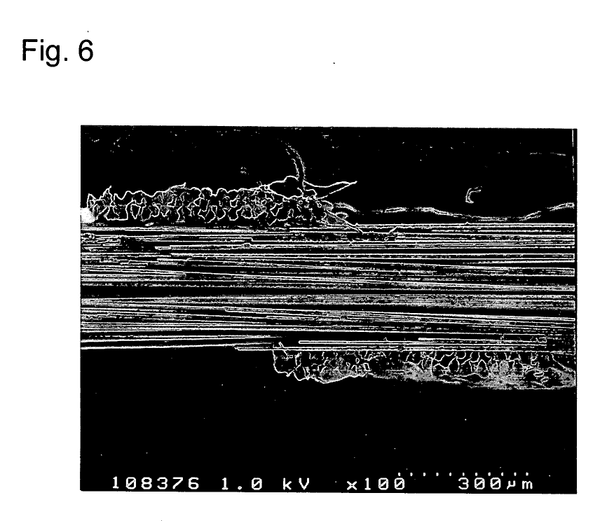

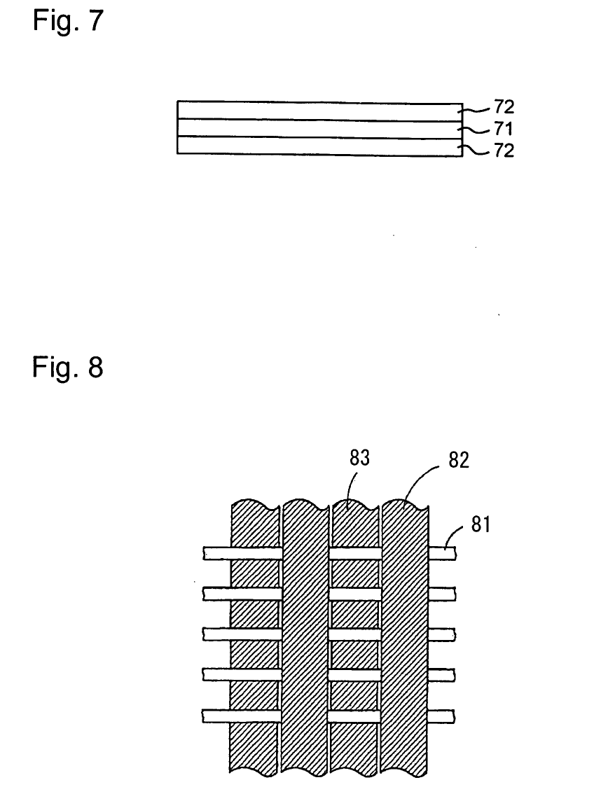

The cross section of the yarn in the width direction of the resulting reinforcing non-woven base fabric was observed under an electron microscope. FIG. 6 shows the photographs. There were found that there were voids among the threads forming the mesh and also that with respect to the mesh and the carbon fiber yarn sheet, the thermoplastic resin impregnated in the mesh was fused and bonded to the carbon fibers.

The bonding agent impregnated in the glass fiber yarns has a water-absorbing property, and the bonding agent is used for binding. Since the yarns that form the glass mesh are also impregnated with the bonding agent, and then dried, they are converged into a round shape to allow the mesh itself to have a sufficient thickness. Since the fibers forming the mesh are made of glass, the resulting reinforcing non-woven base fabric lacks in flexibility, making it difficult for the mesh to follow curved faces, when used for FRP or the like. Since there are voids in the mesh itself to be used for binding, the strength of the mesh is reduced when used for FRP or the like.

### EXAMPLE 2

Yarns prepared by opening a carbon fiber yarn (“PYROFIL (registered trademark)” made by Mitsubishi Rayon Co., Ltd.) of 12K into a yarn width of about 20 mm were used as reinforcing fibers. A group of upper layer yarns in which these yarns were arranged with 4-cm pitches in the length direction as upper threads and a group of lower layer yarns in which the yarns were arranged with 4-cm pitches in a manner so as to be accumulated with an offset of a ½-pitch so that each lower thread was positioned between the upper threads were formed.

An olefin-based heat bonding multifilament (heat bonding PYLEN (registered trademark) 170d; made by Mitsubishi Rayon Co., Ltd.) was used as a support fibrous member. This support fibrous member, which was a multifilament having a core-sheath structure, had a core portion composed of polypropylene having a melting point of 165° C. and a sheath portion composed of polyethylene having a melting point of 98° C., with 60 filaments having a thickness of 170 deniers, and the specific gravity thereof was 0.93.

The above-mentioned carbon fiber yarns were used as warp yarn groups forming two upper and lower layers, and the support fibrous members of olefin-based heat bonding multifilament having a core-sheath structure were used as wefts.

The wefts, aligned in the width direction with 1-cm pitches, were inserted between the upper and lower layers of the warps, and positioned therein. Next, an electric heater roll having a stainless outer layer was placed as an upper roll, and an electric heater roll, which had the same size with an outer layer made of heat-resistant silicon rubber, was placed as a lower roll, and the binding process was carried out by using the fusion-bonding wefts under conditions of an upper roll temperature of 100° C., a lower roll temperature of 80° C., a nip pressure of 1.0 kg/cm and a line speed of 1 m/min; thus, a fiber reinforcing non-woven base fabric with one-direction reinforced was obtained.

The cross section of the resulting reinforcing non-woven base fabric was observed, and in the same manner as the reinforcing non-woven base fabric obtained in example 1, the sheath portions were fused into an integral part, while each of the core portions was maintained in its original shape. Voids such as bubbles were hardly observed between the support fibrous members. The carbon fiber yarn sheet was bonded through an anchor effect by polyethylene that forms the sheath portions having a low melting point.

The one-direction reinforced carbon fiber yarn sheet was bound through the anchor effect by olefin-based multifilament threads that had no water-absorbing property, and since the olefin-based multifilament threads were inherently flexible, the resulting reinforcing non-woven base fabric was flexible, and also allowed to maintain its sheet shape. Since the olefin-based multifilament threads themselves, used for the binding material, contain no bubbles, the strength is nor deteriorated, even when used for FRP or the like.

Since the binding is made by using only the wefts, the weight of the reinforcing non-woven base fabric per 1 m² becomes very small. It is possible to make the amount of use of the support fibrous member to be used for binding greatly smaller. For this reason, in the case of application to FRP, the components other than the reinforcing fiber yarns can be extremely reduced.

The weight per 1 m² of each of the reinforcing non-woven base fabrics in which the respective binding methods are applied to a material in which, as shown in example 2, fiber-extended carbon fiber yarns of 12K with a width of 20 mm are arranged at intervals of 20 mm as reinforced fiber yarns is shown below.

Reinforcing non-woven base fabric of example 2 (using only wefts) 42 g/m²

Application of glass mesh (using mesh)
57 g/m² (Comparative Example 1)

Application of fusion-bonded mesh (680d) (using mesh)
56 g/m² (Example 1)

Application of fusion-bonded mesh (340d) (using mesh)
48 g/m²

Application of fusion-bonded mesh (170d) (using mesh)
44 g/m²

1. A reinforcing non-woven base fabric comprising:
reinforcing fiber yarns that are formed into a sheet shape by using a support fibrous member,
wherein the support fibrous member is formed of multifilament yarn that is made of composite fibers constituted by at least two or more polymers having a difference in melting points.

2. The reinforcing non-woven base fabric according to claim 1, wherein the composite fiber has a core-sheath structure in which the sheath portion is made of a polymer having a lower melting point than that of the core portion.

3. The reinforcing non-woven base fabric according to claim 1 or claim 2, wherein the at least two or more polymers having a difference in melting points are all made of olefin-based polymers.

4. The reinforcing non-woven base fabric according to claim 1, wherein, with respect to the at least the two or more polymers having a difference in melting points, the high melting point polymer is a polypropylene polymer and the low melting point polymer is polyethylene or a low melting point polypropylene polymer.

5. The reinforcing non-woven base fabric according to claim 2, wherein the core-sheath structure of the composite fibers having the core-sheath structure has a polypropylene (core portion)/polyethylene (sheath portion) structure or a polypropylene (core portion)/low melting point polypropylene (sheath portion) structure.

6. The reinforcing non-woven base fabric according to claim 1, wherein not less than two layers thereof are laminated with the reinforcing fiber yarns being used as a group of warp yarns and with the support fibrous member being used as a group of weft yarns.

7. The reinforcing non-woven base fabric according to claim 6, having a three-layer structure in which two upper and lower layers of the groups of warp yarns with a fixed interval are placed, with the group of weft yarns being interpolated therebetween and the lower layer is laminated with an offset of a ½-pitch so as to place the yarn of the group of lower-layer yarns between the yarns of the groups of upper-layer yarns.

8. The reinforcing non-woven base fabric according to claim 1, wherein the support fibrous member has a mesh structure in which multifilament yarns using composite fibers composted of at least two or more polymers having a difference in melting points are used as at least wefts.

9. The reinforcing non-woven base fabric according to claim 1, wherein the sheet shape is maintained through fusion-bonding.

10. The reinforcing non-woven base fabric according to claim 1, wherein the reinforcing fiber yarns are fiber extended yarns.

11. The reinforcing non-woven base fabric according to claim 1, wherein a plurality of reinforcing fiber yarns are aligned in one direction.

12. The reinforcing non-woven base fabric according to claim 1, wherein the reinforcing fibers form biaxial reinforcing fiber yarn sheets that are made of a warp sheet in which the reinforcing fiber yarns are aligned in the length direction and a weft sheet in which the reinforcing fiber yarns are aligned in the width direction.

13. The reinforcing non-woven base fabric according to claim 1, wherein the reinforcing fibers form multi-axial reinforcing fiber yarn sheets that are constituted by ar yarn sheet made of reinforcing fiber yarns which, supposing that the length direction of the sheet is 0°, are aligned in 0°-direction, a yarn sheet made of reinforcing fiber yarns which are aligned in a +α°-direction as well as in a −α°-direction (0<α<90) and a yarn sheet made of reinforcing fiber yarns which are aligned in a 0°-direction and/or in a 90°-direction.
